(19) United States
(12) Patent Application Publication
(10) Pub. No.: US 2012/0209583 A1
(43) Pub. Date: Aug. 16, 2012

(54) COMPUTER PRODUCT, VERIFICATION SUPPORT APPARATUS, AND VERIFICATION SUPPORT METHOD

(75) Inventors: Matthieu PARIZY, Kawasaki (JP); Hiroaki IWASHITA, Kawasaki (JP)

(73) Assignee: FUJITSU LIMITED, Kawasaki-shi (JP)

(21) Appl. No.: 13/289,015

(22) Filed: Nov. 4, 2011

(30) Foreign Application Priority Data
Feb. 10, 2011 (JP) 2011-027949

(51) Int. Cl. G06F 17/50

(52) U.S. Cl. 703/14

(57) ABSTRACT

A computer-readable medium stores therein a verification support program that causes a computer to execute a process including first detecting an assertion that evaluates to true during simulation of a circuit, the assertion being detected from an assertion group prescribing values of registers to be met by the circuit; updating, at a clock tick subsequent to a clock tick at which the assertion is detected at the first detecting, an expected value of a register, to a value of the register as prescribed by the assertion; second detecting inconsistency between the expected value that has been updated at the updating and the value of the register; determining, based on a detection result obtained at the second detecting, validity of a change in the value of the register; and outputting a determination result obtained at the determining.

### CROSS REFERENCE TO RELATED APPLICATIONS

This application is based upon and claims the benefit of priority of the prior Japanese Patent Application No. 2011-027949, filed on Feb. 10, 2011, the entire contents of which are incorporated herein by reference.

### FIELD

The embodiments discussed herein are related to circuit verification.

### BACKGROUND

Conventionally, simulations using assertions concerning a circuit-under-test as well as simulations that monitor registers of a circuit-under-test have been disclosed (see, for example, Japanese Laid-open Patent Publication No. 2008-181227)

Nonetheless, with the conventional arts above a problem arises in that if a suitable model of the behavior of a circuit-under-test is to be generated according to specifications and the specifications are complicated, the generation of a circuit model that behaves correctly is extremely time consuming.

Meanwhile, even when the accuracy of a circuit model is low, if an assertion (also referred to as an assertion property and a verification property) concerning a circuit-under-test can be correctly described from the specifications, the occurrence of an error in the behavior of the circuit-under-test can be detected in the circuit model. However, if the verification engineer is to describe the assertion concerning the circuit-under-test and multiple verification scenarios exist for one register, a problem arises in that description of the assertion is difficult.

Accordingly, a change in a register value occurring outside assertion-defined verification scenarios cannot be detected by assertions. Further, if the circuit-under-test operates under multiple clocks, the behavior of the circuit model becomes more complicated, making the detection of a change in a register value, occurring outside the assertion-defined verification scenarios more difficult.

### SUMMARY

According to an aspect of an embodiment, a computer-readable medium stores therein a verification support program that causes a computer to execute a process including first detecting an assertion that evaluates to true during simulation of a circuit, the assertion being detected from an assertion group prescribing values of registers to be met by the circuit; updating, at a clock tick subsequent to a clock tick at which the assertion is detected at the first detecting, an expected value of a register, to a value of the register as prescribed by the assertion; second detecting inconsistency between the expected value that has been updated at the updating and the value of the register; determining, based on a detection result obtained at the second detecting, validity of a change in the value of the register; and outputting a determination result obtained at the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of an example of checking a circuit-under-test by assertions according to a first embodiment.

FIG. 2 is a block diagram of a hardware configuration of a verification support apparatus according to the first embodiment.

FIG. 3 is a block diagram of a functional configuration of the verification support apparatus according to the first embodiment.

FIG. 4 is a block diagram of an example of a functional configuration of a checker module.

FIG. 5 is a flowchart of a modification process for an assertion group 310, executed by the verification support apparatus according to the first embodiment.

FIG. 6 is a flowchart of an expected-value updating process executed by a checker module CMi during simulation of the circuit-under-test.

FIG. 7 is a flowchart of a validity detection process executed by the checker module CMi during simulation of the circuit-under-test.

FIG. 8 is a diagram of an example of a false error occurring in the case of multiple clocks.

FIGS. 9, 10, 11, 12, and 13 are diagrams of a first example of error detection operation under multiple clocks.

FIGS. 14, 15, 16, 17, and 18 are diagrams of a second example of error detection operation under multiple clocks.

FIG. 19 is a block diagram of a functional configuration of the verification support apparatus according to a second embodiment.

FIG. 20 is a block diagram of a functional configuration of a co-checker module group CCMi.

FIG. 21 is a flowchart of a modification/creation process executed by the verification support apparatus according to the second embodiment.

FIG. 22 is a flowchart of an ‘assertion true’ notification process executed by a co-checker module CCMij during simulation of the circuit-under-test.

FIG. 23 is a flowchart of a startup process executed by the co-checker module CCMij, for a check process CPij occurring during simulation of the circuit-under-test.

FIG. 24 is a flowchart of an execution process of the check process CPij started according to the flowchart depicted in FIG. 23.

### DESCRIPTION OF EMBODIMENTS

Preferred embodiments of the present invention will be explained with reference to the accompanying drawings. Hereinafter, a circuit-under-test operating under a single clock will be described in a first embodiment, while a circuit-under-test operating under multiple clocks will be described in a second embodiment. Additionally, a register that is in the circuit-under-test and checked by an assertion will be referred to as “register R”.

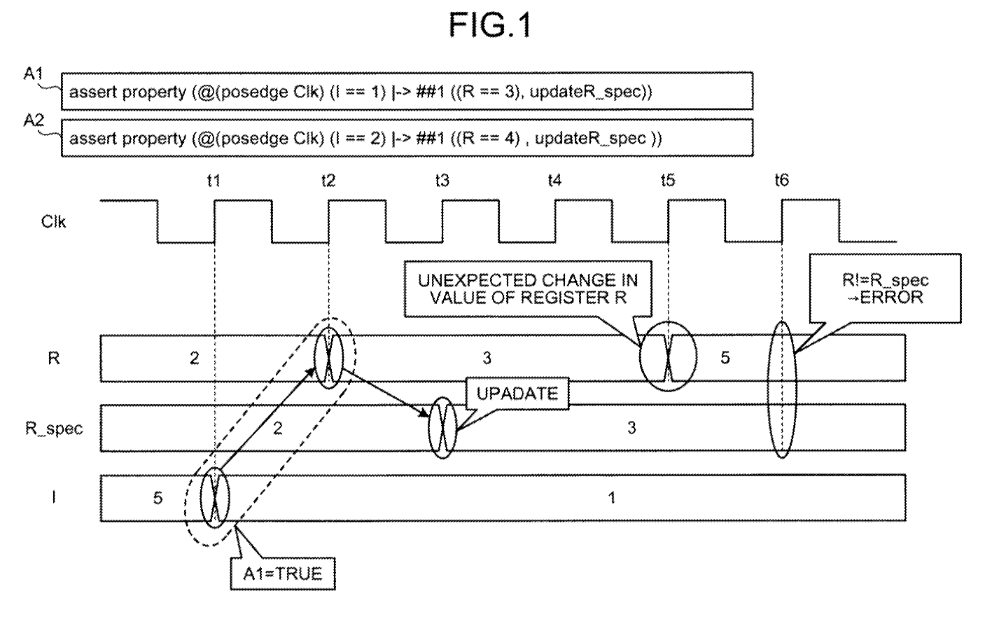

FIG. 1 depicts an example of checking a circuit-under-test by assertions according to a first embodiment. An assertion is data defining behavior that the design of a circuit-under-test must satisfy. In FIG. 1, as one example, assertions A1, A2 are defined. Assertion A1, for example, described in a hardware language such as Verilog.

Assertion A1 confirms that “if ‘1’ is input as input I at a rising edge of clock Clk, the value of register R changes to ‘3’ after 1 cycle”. Assertion A2 confirms that “if ‘2’ is input as input I at a rising edge of clock Clk, the value of register R changes to ‘4’ after 1 cycle”.

Further, “updateR_spec” is described in assertions A1, A2. Description, like “updateR_spec”, inserted at the tail of an assertion is sub-assertion that a subroutine called up if the assertion to which the sub-assertion has been inserted, evaluates to true. Here, the inserted description “updateR_spec” instructs the updating of an expected value R_spec. Thus, if the assertion to which the sub-assertion has been inserted is assertion A1 and if assertion A1 evaluates to true, the expected value R_spec is updated to “3”, the value of register R for assertion A1.

Further, the circuit-under-test operates according to clock Clk and is a circuit model for which input I and the behavior of register R are prescribed. Specifically, input I changes from “5” to “1” at clock tick t1, a rising edge of clock Clk. Further, register R changes from “2” to “3” at clock tick t2, a rising edge of clock Clk, and changes from “3” to “5” at clock tick t5.

Here, since input I has changed from “5” to “1” at clock tick t1 and the value of register R has changed from “2” to “3” at clock tick t2, a rising edge one cycle thereafter, it is confirmed that assertion A1 evaluates to true.

Thus, if it is confirmed that assertion A1 evaluates to true, the expected value R_spec of register R is updated from “2” to “3” at clock tick t3, a rising edge one cycle later. Consequently, the expected value R_spec of register R at clock tick t3 (a rising edge) and thereafter is R_spec=3, coinciding with the value of register R (R=3) in the circuit model for which assertion A1 evaluates to true, enabling consistency to be maintained.

On the other hand, although the value of register R has changed from “3” to “5” at clock tick t5, a rising edge of clock Clk, this change is not expected according to either assertion A1 or A2. Specifically, at clock tick t6, a rising edge one cycle thereafter, the value of register R “5” and the expected value R_spec “3” do not coincide, thereby a change in the value of register R, occurring outside the assertion is detected as an error.

Thus, in the present embodiment, if assertion A1, A2 evaluates to true like the behavior at clock ticks t1 to t2 (rising edges) and the expected value R_spec of register R is updated to the value of register R when assertion A1, A2 evaluates to true, the value of register R and the expected value R_spec will coincide after assertion A1, A2 has evaluated to true. Therefore, once assertion A1, A2 has evaluated to true, it can be guaranteed that no change has occurred in the value of register R until an unexpected change of register R occurs outside assertion A1, A2 concerning circuit-under-test.

On the other hand, if a change in the value of register R occurs outside assertion A1, A2, like the unexpected change in the value of register R at clock tick t5 (a rising edge), the unexpected change is reported as an error, whereby a bug can be easily identified irrespective the lack of such definition by assertions A1, A2. Thus, bugs occurring in scenarios not defined by assertions A1, A2 can be detected and therefore, even if the behavior of the circuit-under-test cannot be covered by an assertion, bug detection is possible.

By the verification engineer debugging identified bugs, the value of register R can be guaranteed to not change outside the assertions concerning the circuit-under-test.

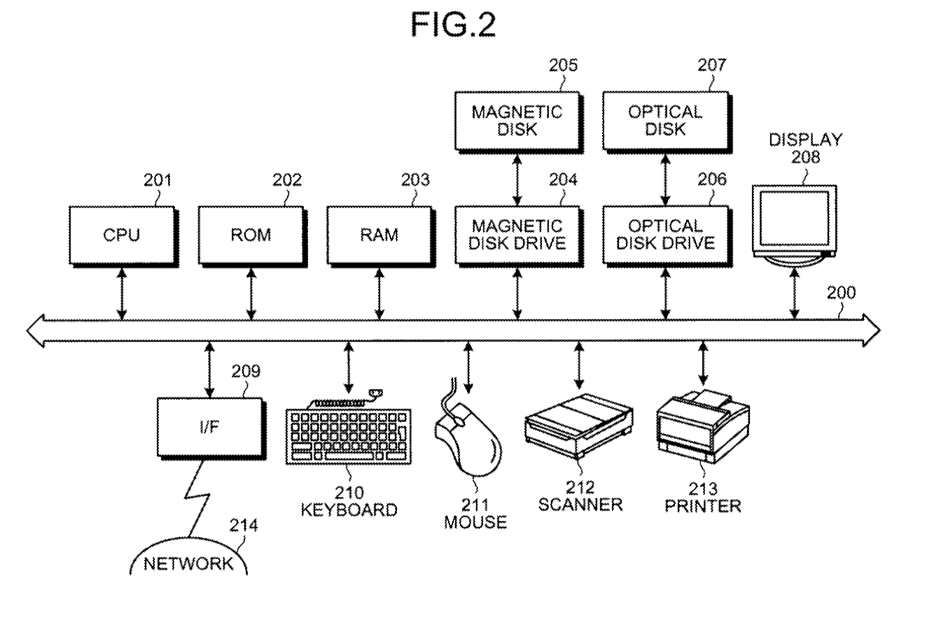

FIG. 2 is a block diagram of a hardware configuration of the verification support apparatus according to the first embodiment. As depicted in FIG. 2, the verification support apparatus includes a central processing unit (CPU) 201, a read-only memory (ROM) 202, a random access memory (RAM) 203, a magnetic disk drive 204, a magnetic disk 205, an optical disk drive 206, an optical disk 207, a display 208, an interface (I/F) 209, a keyboard 210, a mouse 211, a scanner 212, and a printer 213, respectively connected by a bus 200.

The CPU 201 governs overall control of the verification support apparatus. The ROM 202 stores therein programs such as a boot program. The RAM 203 is used as a work area of the CPU 201. The magnetic disk drive 204, under the control of the CPU 201, controls the reading and writing of data with respect to the magnetic disk 205. The magnetic disk 205 stores therein data written under control of the magnetic disk drive 204.

The optical disk drive 206, under the control of the CPU 201, controls the reading and writing of data with respect to the optical disk 207. The optical disk 207 stores therein data written under control of the optical disk drive 206, the data being read by a computer.

The display 208 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 208.

The I/F 209 is connected to a network 214 such as a local area network (LAN), a wide area network (WAN), and the Internet through a communication line and is connected to other apparatuses through the network 214. The I/F 209 administers an internal interface with the network 214 and controls the input/output of data from/to external apparatuses. For example, a modem or a LAN adaptor may be employed as the I/F 209.

The keyboard 210 includes, for example, keys for inputting letters, numerals, and various instructions and performs the input of data. Alternatively, a touch-panel-type input pad or numeric keypad, etc. may be adopted. The mouse 211 is used to move the cursor, select a region, or move and change the size of windows. A track ball or a joy stick may be adopted provided each respectively has a function similar to a pointing device.

The scanner 212 optically reads an image and takes in the image data into the verification support apparatus. The scanner 212 may have an optical character reader (OCR) function as well. The printer 213 prints image data and text data. The printer 213 may be, for example, a laser printer or an ink jet printer.

Next, an example of a functional configuration of the verification support apparatus according to the first embodiment will be described.

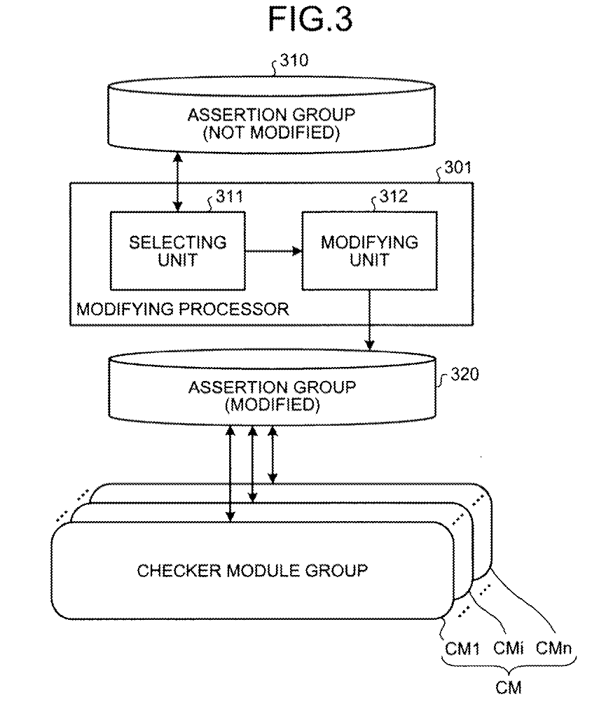

FIG. 3 is a block diagram of a functional configuration of the verification support apparatus according to the first embodiment. The verification support apparatus includes a modifying processor 301 and a checker module group CM. The modifying processor 301 includes a selecting unit 311 and a modifying unit 312. Functions of the modifying processor 301 (the selecting unit 311 and the modifying unit 312) and the checker module group CM are implemented, specifically, for example, by the CPU 201 executing a program stored in a storage device such as the ROM 202, the RAM 203, the magnetic disk 205, and the optical disk 207 depicted in FIG. 2, or via the I/F 209.

Assertion groups 310, 320 are collections of assertions concerning the circuit-under-test. The assertion group 310 is an assertion group prior to modification by the modifying processor 301. The assertion group 310 includes assertions into which “updateR_spec” has not been inserted, such as assertions A1, A2 depicted in FIG. 1, without “updateR_spec”. On the other hand, the assertion group 320 is the assertion group 310 after modification by the modifying processor 301. Assertions in the assertion group 320 include, for example, assertions A1, A2 depicted in FIG. 1.

The selecting unit 311 selects from the assertion group 310, an assertion that has yet to be selected. The selecting unit 311 continues selecting assertions until no unselected assertion remains. The modifying unit 312 inserts into the assertion selected by the selecting unit 311 (selected assertion), update instruction description instructing an update of the expected value of the register in the circuit-under-test. The inserted update instruction description is description that calls up an expected-value updating subroutine.

The update instruction description is, for example, “updateR_spec” depicted in FIG. 1. “UpdateR_spec” is a subroutine that updates “R_spec” of the assertion into which “updateR_spec” has been inserted. Thus, at the modifying unit 312, the update instruction description is inserted into each selected assertion, whereby after modification, the assertion group 320 is generated. The modified assertion group 320 is referred to by the checker module group CM.

The checker module group CM includes n checker modules CM1, . . . , CMi, . . . , CMn, respectively prepared for each register in the circuit-under-test (where, n is the number of registers defined by assertions). The checker modules Cmi execute the same processing, but the registers and assertions (assertions in the assertion group 320) subject to the processing respectively differ among the checker modules Cmi.

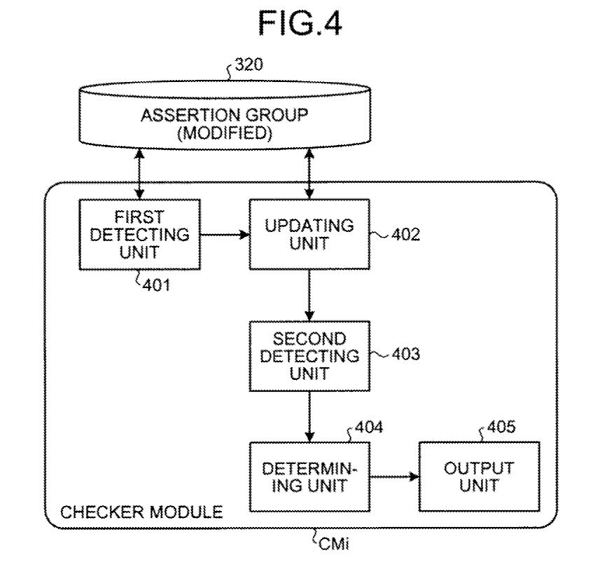

FIG. 4 is a block diagram of an example of a functional configuration of a checker module. A checker module CMi includes a first detecting unit 401, an updating unit 402, a second detecting unit 403, a determining unit 404, and an output unit 405. Functions of the first detecting unit 401 to the output unit 405 are implemented, specifically, for example, by the CPU 201 executing a program stored to a storage device such as the ROM 202, the RAM 203, the magnetic disk 205, and the optical disk 207 depicted in FIG. 2, or via the I/F 209.

The first detecting unit 401 detects an assertion that evaluates to true during simulation of the circuit-under-test operating under a single clock. The assertion is detected from the assertion group 320 prescribing register R values to be met by the circuit-under-test. Operation under a single clock Clk may be with respect to the entire circuit-under-test or a portion of the circuit-under-test such as a circuit block. During simulation, the first detecting unit 401 detects an assertion (an assertion in the assertion group 320) that evaluates to true for a register R checked by the checker module CMi. For example, as depicted in FIG. 1, the first detecting unit 401, at clock tick t2 of the single clock Clk, detects that, among assertions A1 and A2, assertion A1 has evaluated to true.

The updating unit 402, at the clock tick subsequent to the clock tick when the assertion is detected by the first detecting unit 401, updates the expected value R_spec of register R to the value of register R prescribed by the assertion. Specifically, the updating unit 402 is an updating subroutine updating the expected value R_spec by executing the update instruction description “updateR_spec” of the assertion that has evaluated to true. Thus, the expected value R_spec is updated at the clock tick subsequent to the clock tick of detection, to the value of register R under simulation (i.e., the value of register R prescribed by the assertion that has evaluated to true). Therefore, if the circuit-under-test has been correctly designed and provided that an assertion does not evaluate to true, after the updating by the updating unit 402, the value of register R and the expected value R_spec should continue to be the same value.

The second detecting unit 403 detects inconsistency between the expected value R_spec of register R after the updating by the updating unit 402 and the value of register R. Specifically, for example, the second detecting unit 403 monitors changes in the value of register R under test by the checker module CMi, at each rising edge clock tick of clock Clk (or falling edge clock tick). Thus, if the circuit-under-test has been correctly designed and provided none of the assertions concerning register R in the assertion group 320 evaluates to true, the value of register R and the expected value R_spec should be consistent. On the other hand, inconsistency indicates a change in the value of register R, not defined by the assertion group 320.

The determining unit 404, based on the detection result obtained by the second detecting unit 403, determines whether the change in the value of register R is valid. Specifically, for example, if inconsistency is detected by the second detecting unit 403, the determining unit 404 determines the change in the value of register R to be a change not prescribed by the assertion group 320 (erroneous change). On the other hand, if consistency is detected by the second detecting unit 403, the change in the value of register R is determined to be an expected change (correct change).

Configuration may be such that the determining unit 404 executes determination processing only when inconsistency is detected by the second detecting unit 403. Although the second detecting unit 403 executes determination processing at each execution of detection processing, presumably the number of detections of inconsistency is lower than the number of detections of consistency and therefore, the execution of determination processing only upon detection of inconsistency can facilitate faster verification support processing.

The output unit 405 outputs a determination result obtained by the determining unit 404. Specifically, for example, if the determining unit 404 has determined a change to be an erroneous change, the output unit 405 outputs identification information for register R and the clock tick at which the inconsistency of register R was detected. Identification information is information uniquely identifying register R, e.g., a register name. For instance, in the example depicted in FIG. 1, the output unit 405 outputs {NG, clock tick t5, R}.

Further, the output unit 405 outputs identification information for register R and the clock tick that is one cycle subsequent to the clock tick at which the inconsistency of register R was detected. For instance, in the example depicted in FIG. 1, the output unit 405 outputs {NG, clock tick t6, R}. Here, the value of register R may also be output. In this case, the output unit 405 outputs {NG, clock tick t6, R=5}. Further, configuration may be such that the output unit 405 outputs identification information for register R and the clock tick at which consistency was detected, if the determining unit 404 has determined a change to be a correct change. For instance, in the example depicted in FIG. 1, the output unit 405 outputs {OK, clock tick t3, R}.

The output unit 405 may output such results by display on the display 208, print out by the printer 213, transmission to a communicable computer, etc. Further, the output unit 405 may store the results to an internal storage device (RAM 203, magnetic disk 205) of the verification support apparatus.

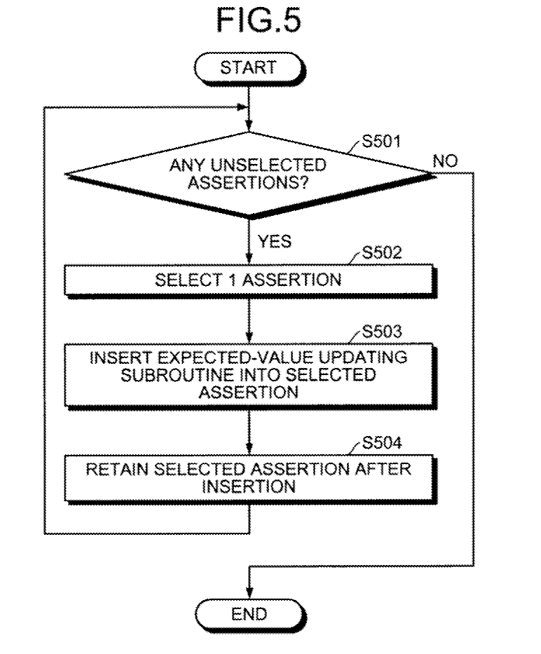

FIG. 5 is a flowchart depicting a modification process for the assertion group 310, executed by the verification support apparatus according to the first embodiment. The selecting unit 311 judges whether an assertion that has yet to be selected remains in the assertion group 310 (step S501).

If an unselected assertion remains (step S501: YES), the selecting unit 311 selects an unselected assertion from the assertion group 310 (step S502). The modifying unit 312 inserts into the selected assertion, the update instruction description that calls up the expected-value updating subroutine (step S503). Thereafter, the modifying unit 312 retains the selected assertion after the insertion, in an internal storage device of the verification support apparatus (step S504), and the flow returns to step S501.

At step S501, if no unselected assertion remains (step S501: NO), the modification has been completed, ending the modification process. Thus, the unmodified assertion group 310 is modified into the assertion group 320 into which the update instruction description has been inserted, whereby the expected value R_spec can be automatically updated when an assertion evaluates to true in the check process of the checker module group CM.

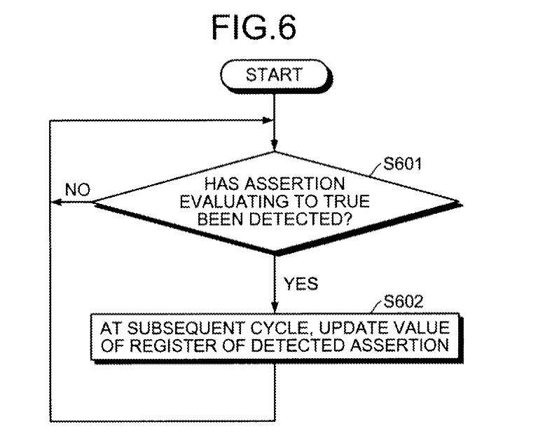

FIG. 6 is a flowchart depicting an expected-value updating process executed by the checker module CMi during simulation of the circuit-under-test.

First, the checker module Cmi waits until the first detecting unit 401 detects in the assertion group 320, an assertion evaluating to true for a register R under test by the checker module CMi (step S601: NO). When an assertion is detected (step S601: YES), the updating unit 402, at the subsequent cycle (the subsequent clock tick), updates the value of register R of the detected assertion to the expected value R_spec (step S602), and the flow returns to step S601. The processing in the flowchart depicted in FIG. 6 ends with the completion of the simulation of the circuit-under-test.

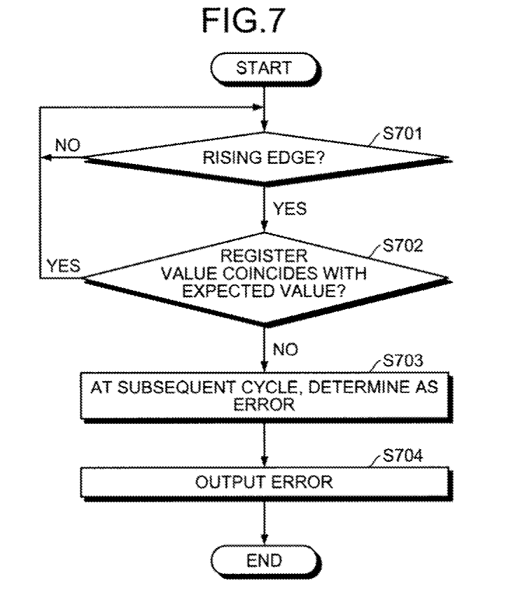

FIG. 7 is a flowchart of a validity detection process executed by the checker module CMi during simulation of the circuit-under-test. In FIG. 7, detection at a rising edge clock tick of clock Clk is given as an example, nonetheless detection may be at a falling edge clock tick.

First, the second detecting unit 403 awaits a rising edge clock tick of clock Clk (step S701: NO), and upon a rising edge clock tick (step S701: YES), judges whether the value of register R and the expected value R_spec are consistent (step S702). If the values are consistent (step S702: YES), the flow returns to step S701.

On the other hand, if the values are inconsistent (step S702: NO), the determining unit 404, at the subsequent cycle (the subsequent clock tick), determines the change in the value of register R to be an erroneous change not prescribed by the assertion group 320 (step S703). The output unit 405 outputs a determination result (step S704), and the flow returns to step S701. The processing in the flowchart depicted in FIG. 7 ends with the completion of the simulation of the circuit-under-test.

Thus, in the first embodiment, each time an assertion evaluates to true, the expected value R_spec is updated to the value of register R, whereby after the update, the value of register R and the expected value R_spec continue to coincide if the design is correct. Therefore, if an inconsistency between the value of register R and the expected value R_spec is detected, irrespective of none of the assertions in the assertion group 320 evaluating to true, the value of register R has changed.

Therefore, since the change is clearly not one prescribed by any of the assertions in the assertion group 320, a bug that cannot be detected by the assertion group can be efficiently detected. Further, by the verification engineer debugging identified bugs, the value of register R can be guaranteed to not change outside the assertions concerning the circuit-under-test.

In addition, although the circuit-under-test of the first embodiment has been described as a circuit operating under a single clock Clk, the circuit-under-test may operate under multiple clocks, where each clock domain is subject to verification, enabling application of the first embodiment.

Next, a second embodiment will be described. In the first embodiment, 1 clock operates register R under verification. Therefore, by inserting update instruction description in an assertion, when the assertion evaluates to true, the expected value R_spec is updated, creating a state in which “if the design is correct, the value of register R and the expected value R_spec will coincide”. Consequently, if the value of register R and the expected value R_spec do not coincide, the unexpected change in the value of register R is detected to be an erroneous change not defined by any assertion in the assertion group 320.

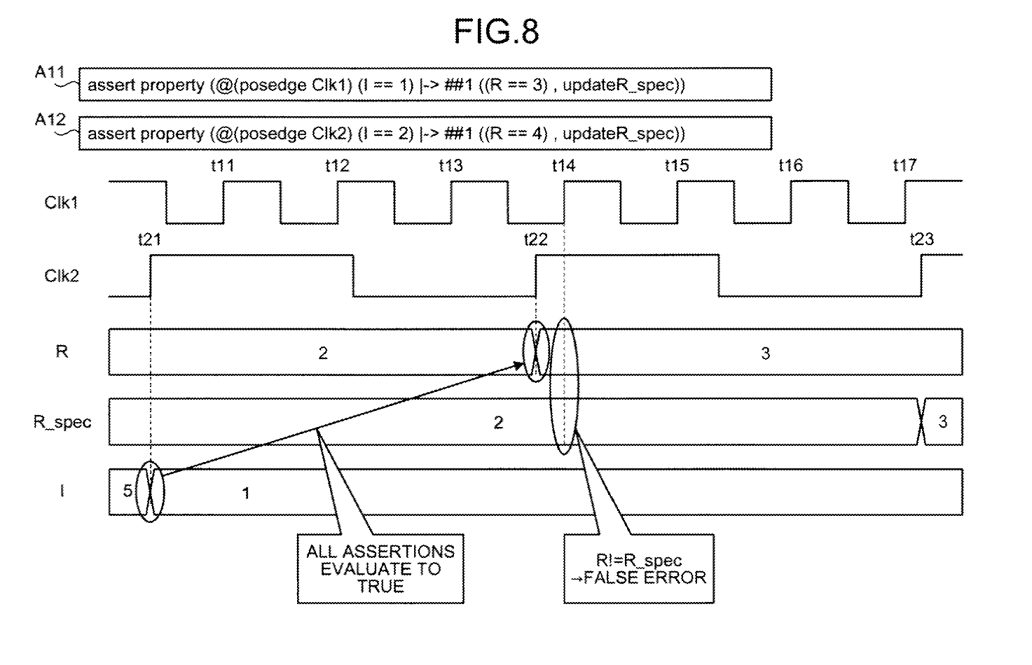

In contrast, if multiple clocks operate register R under verification, a false error occurs. Specifically, if the expected value R_spec is updated at the clock tick subsequent to the clock tick when an assertion evaluates to true as in the first embodiment and the subsequent clock tick belongs to a clock different from the clock of the clock tick at which the assertion evaluated to true, the value of register R and the expected value R_spec do not coincide. Here, description is given with reference to FIG. 8.

FIG. 8 depicts an example of a false error occurring in the case of multiple clocks. In FIG. 8, assertions A11, A12 are prescribed concerning register R. Assertion A11 is an assertion confirming that “at a rising edge of clock Clk1, if ‘1’ is input as input I, 1 cycle thereafter, the value of register R changes to ‘3’”. Assertion A12 is an assertion confirming that “at a rising edge of clock Clk2, if ‘2’ is input as input I, 1 cycle thereafter, the value of register R changes to ‘4’”.

In FIG. 8, if the value of input I changes from “5” to “1” at clock tick t21, a rising edge of clock Clk2, the value of register R changes from “2” to “3” at clock tick t22, a rising edge of clock Clk2. Consequently, assertion A11 evaluates to true, and as in the first embodiment, the expected value R_spec of register R is updated at the subsequent clock tick (clock tick t23, a rising edge of clock Clk2).

Thus, at clock ticks t14 to t17 (rising edges of clock Clk1) occurring temporally between clock ticks t22 to t23 (rising edges of clock Clk2), a discrepancy between the value of register R and the expected value R_spec (“3”≠“2”) occurs. In other words, between clock ticks t22 to t23 (rising edges of clock Clk2), irrespective of operation according to assertion A11, an error of assertion A11 evaluating to false is detected.

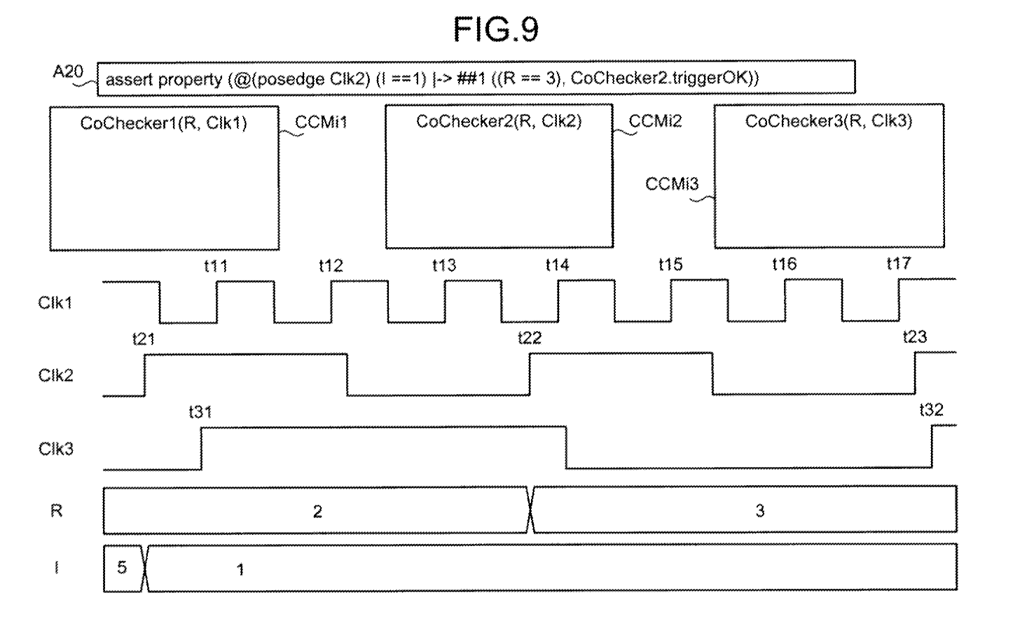

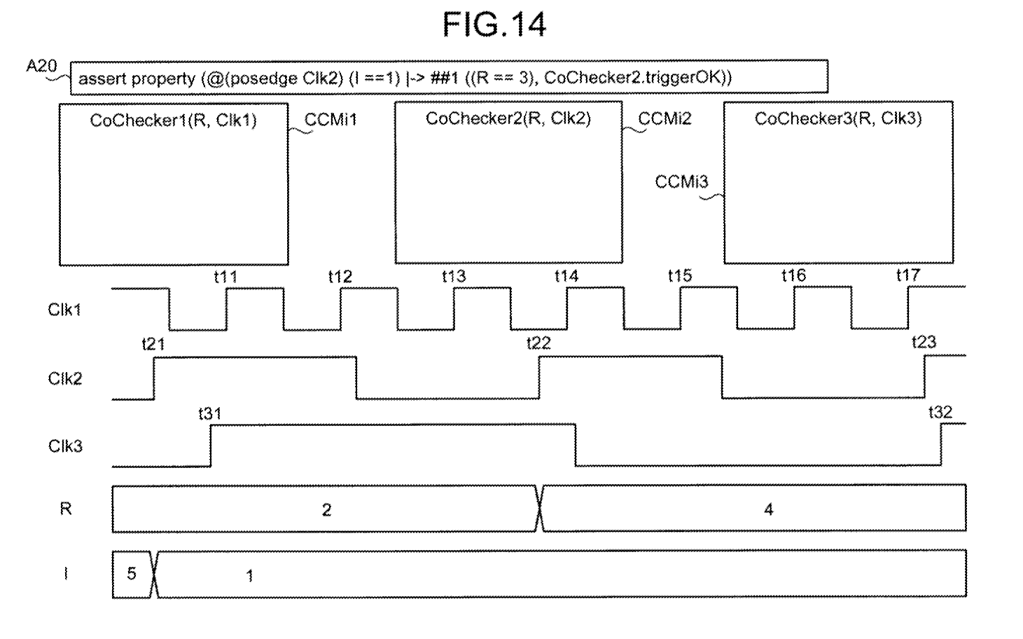

Therefore, an example in the second embodiment will be described where even if register R in the circuit-under-test operates under multiple clocks, bugs that cannot be detected by the assertion group 320 are efficiently detected, without the occurrence of the false error described above. In the second embodiment, description is given with respect to 3 clocks (clocks Clk1 to Clk3) as one example. Further, with respect to FIGS. 9 to 13, an example where an error does not occur will be described, whereas with respect to FIGS. 14 to 18, an example where an error occurs will be described.

FIGS. 9 to 13 depict a first example of error detection operation under multiple clocks. The first example of error detection operation is an example of operation that, when assertion A20 evaluates to true, checks the assertion A20 evaluation to true, without the false error described above occurring.

FIG. 9 depicts an initial state. In FIG. 9, with respect to a given register R, a co-checker module is prepared for each clock. CoChecker1 (R, Clk1) is a co-checker module CCMi1 detecting assertion evaluation to true occurring when register R operates under clock Clk1. CoChecker2 (R, Clk2) is a co-checker module CCMi2 detecting assertion evaluation to true occurring when register R operates under clock Clk2.

CoChecker3 (R, Clk3) is a co-checker module CCMi3 detecting assertion evaluation to true occurring when register R operates under clock Clk3. Thus, with respect to a given register R, the number of co-checker modules created corresponds to the number of clocks.

Further in FIGS. 9 to 13, an example is given of detecting whether assertion A20 evaluates to true. Assertion A20 is an assertion confirming that “at a rising edge of clock Clk2, if ‘1’ is input as input I, 1 cycle thereafter, the value of register R changes to ‘3’”.

“CoChecker2.triggerOK” inserted into assertion A20 is a subroutine called up if the assertion (assertion A20) to which the “CoChecker2.triggerOK” has been inserted, evaluates to true. “CoChecker2.triggerOK” is a notification subroutine giving ‘assertion true’ notification of “OK” to the check process in the co-checker module CCMi2.

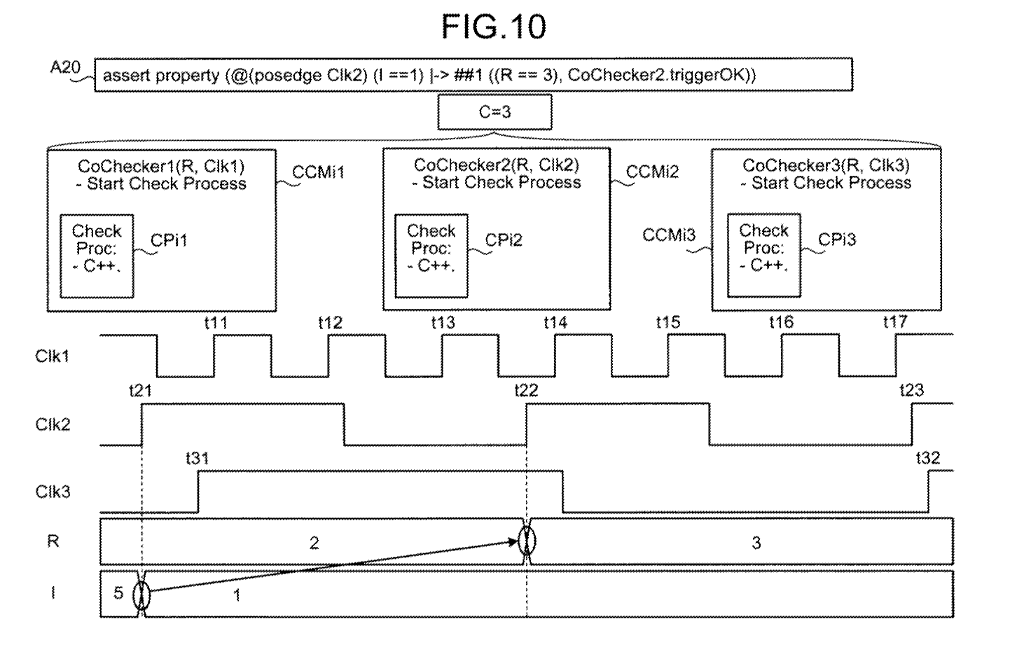

FIG. 10 depicts a transition from the state depicted in FIG. 9. In FIG. 10, check processes CPi1 to CPi3 respectively in the co-checker modules CCMi1 to CCMi3, are in a starting state. The check processes CPi1 to CPi3 start upon detection of a change in the value of register R.

In FIG. 10, since the value of input I changes from “5” to “1” at clock tick t21 (a rising edge of clock Clk2), the value of register R changes from “2” to “3” at clock tick t22 (a rising edge of clock Clk2). This behavior satisfies assertion A20. Since the value of register R has changed from “2” to “3” at clock tick t22 of clock Clk2, the check processes CPi1 to CPi3 start at clock tick t22 of clock Clk2.

When the check processes CPi1 to CPi3 start, a global variable C in the check processes CPi1 to CPi3 is incremented. In the present example, since there are 3 co-checker modules, C equals 3, i.e., the global variable C is equal to the number of clocks under which the given register R operates. C is successively decremented.

C is decremented and if all of the check processes CPi1 to CPi3 have ended before C becomes 0, the evaluation to true of assertion A20 can be appropriately confirmed, without the false error depicted in FIG. 8 occurring between clock tick t22 when assertion A20 evaluates to true and the subsequent clock tick t23 (rising edges of clock Clk2). On the other hand, if C equals 0 when all of the check processes CPi1 to CPi3 end, a change in the value of register R, not defined by any assertion in the assertion group, has been detected.

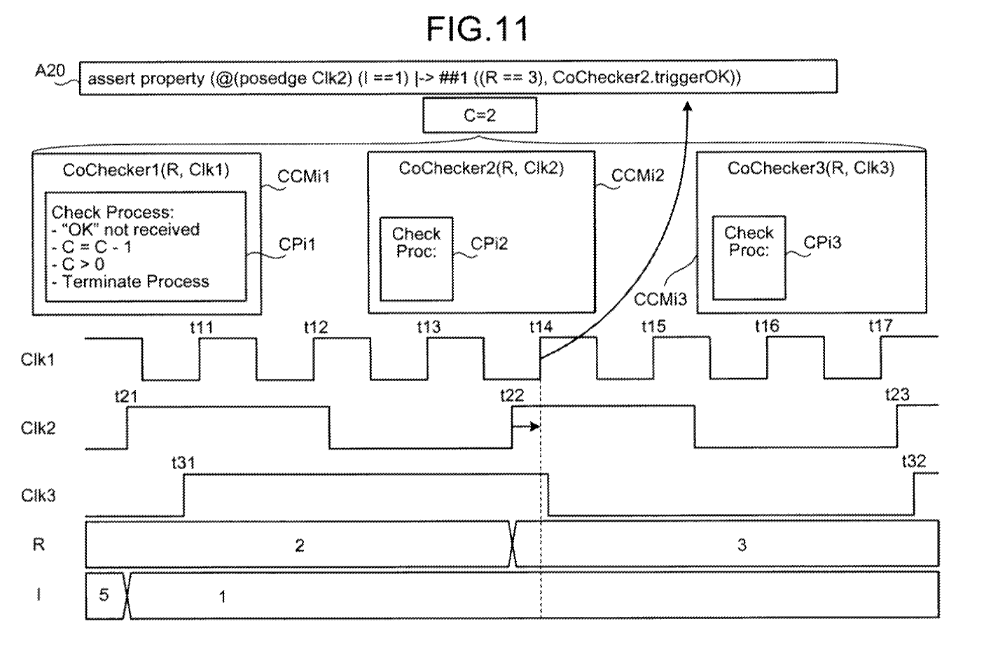

FIG. 11 depicts state transition from the state depicted in FIG. 10. In the description of FIG. 11, the clock tick at which register R operates subsequent to clock tick t22 when assertion A20 evaluates to true is clock tick t14 of clock Clk1. Therefore, in co-checker module CCMi1 monitoring operation under clock Clk1, ‘assertion true’ notification of “OK” for assertion A20 is awaited, but at clock tick t14 assertion A20 does not evaluate to true. Therefore, in co-checker module CCMi1, since ‘assertion true’ notification of “OK” is not received at clock tick t14, the check process CPi1 decrements C, whereby C equals 2, and the check process CPi1 ends.

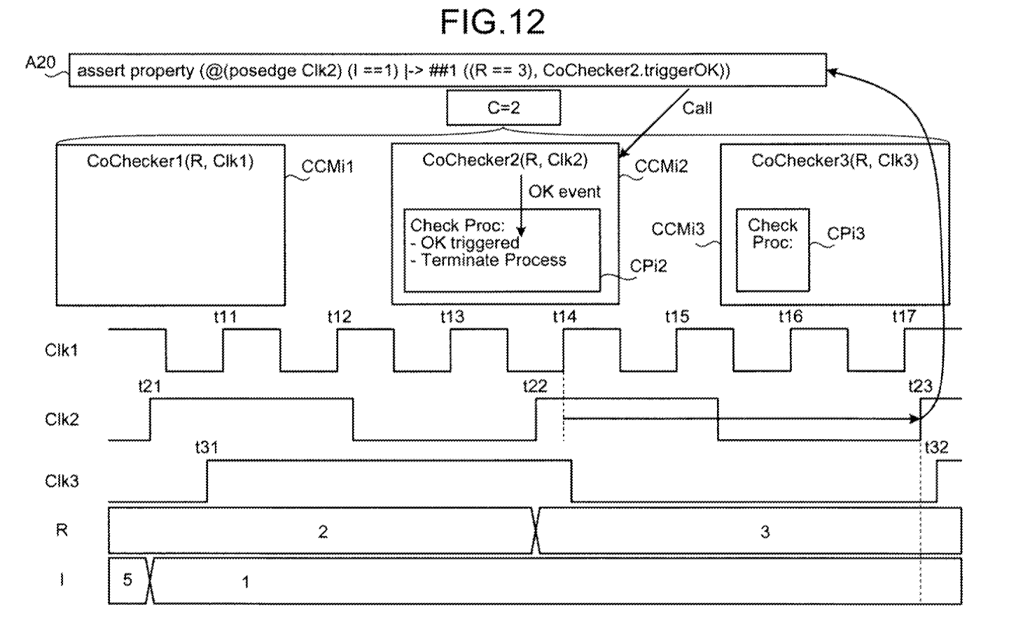

FIG. 12 depicts state transition from the state depicted in FIG. 11. In the description of FIG. 12, clock ticks at which register R operates subsequent to clock tick t14 (a rising edge of clock Clk1) when the check process CPi1 ends are clock ticks t15 to t17 (rising edges of clock Clk1), but the check process CPi1 of co-checker module CCMi1 has ended. Therefore, the clock tick at which register R operates subsequent to clock tick t17 of clock Clk1 is clock tick t23 (a rising edge of clock Clk2) and in co-checker module CCMi2 monitoring operation under clock Clk2, ‘assertion true’ notification of “OK” for assertion A20 is awaited.

Clock tick t23 is the clock tick subsequent to clock tick t22 when assertion A20 evaluates to true and therefore, notification subroutine “CoChecker2.triggerOK” of co-checker module CCMi2 is called up. Consequently, co-checker module CCMi2 issues ‘assertion true’ notification of “OK” for assertion A20 to the check process CPi2, enabling the check process CPi2 to receive ‘assertion true’ notification of “OK” for assertion A20. The check process CPi2 having received ‘assertion true’ notification of “OK”, does not decrement C (i.e., leaves C=2 as is) and ends.

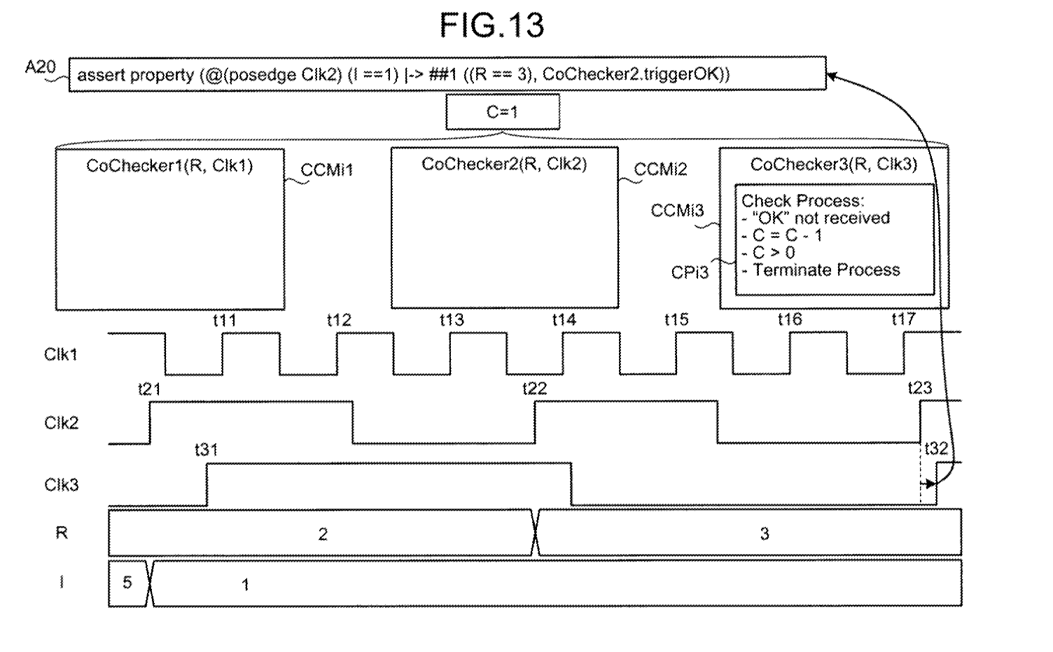

FIG. 13 depicts state transition from the state depicted in FIG. 12. In the description of FIG. 13, the clock tick at which register R operates subsequent to clock tick t23 of clock Clk2 at which the check process CPi2 ends is clock tick t32 (a rising edge of clock Clk3). Therefore, in co-checker module CCMi3 monitoring operation under clock Clk3, ‘assertion true’ notification of “OK” for assertion A20 is awaited, but at clock tick t32, assertion A20 does not evaluate to true.

Consequently, in co-checker module CCMi3, since ‘assertion true’ notification of “OK” is not received at clock tick t32, the check process CPi3 decrements C, whereby C equals 1, and the check process CPi3 ends. Therefore, before C becomes 0, the check processes CPi1 to CPi3 end.

In this way, in the second embodiment, the evaluation to true of assertion A20 can be appropriately confirmed, without the false error depicted in FIG. 8 occurring between clock tick t22 when assertion A20 evaluates to true and clock tick t23 (rising edges of clock Clk2).

FIGS. 14 to 18 depict a second example of error detection operation under multiple clocks. The second example of error detection operation is an operation example of detecting, without the occurrence of the false error described above, a change in the value of register R (a change not defined by any assertion in the assertion group), when assertion A20 evaluates to false.

FIG. 14 depicts an initial state. As depicted in FIG. 14, with respect to a given register R, co-checker modules CCMi1 to CCMi3 are prepared for each clock. The initial state depicted in FIG. 9 and the initial state depicted in FIG. 14 differ in that in FIG. 9, the value of register R changes from “2” to “3” at clock tick t22 (a rising edge of clock Clk2), whereas in FIG. 14, the value of register R changes from “2” to “4” at clock tick t22 (a rising edge of clock Clk2).

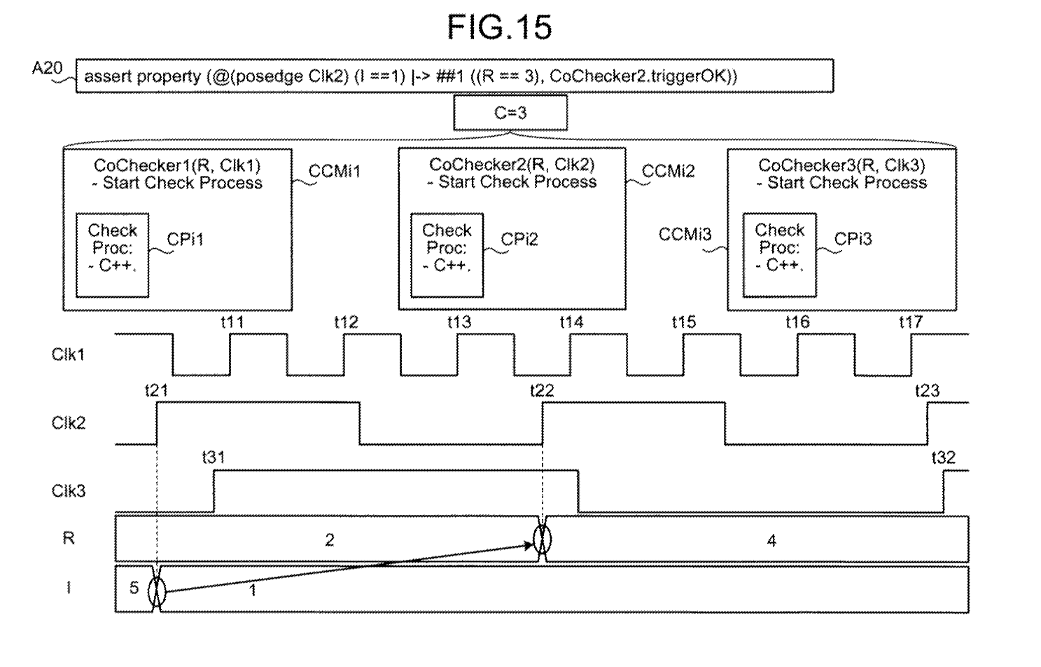

FIG. 15 depicts state transition from the state depicted in FIG. 14. In FIG. 15, the check processes CPi1 to CPi3 respectively in the co-checker modules CCMi1 to CCMi, are in a starting state. The check processes CPi1 to CPi3 start upon detection of a change in the value of register R.

In FIG. 15, in response to the value of input I changing from “5” to “1” at clock tick t21 (a rising edge of clock Clk2), the value of register R changes from “2” to “4” at clock tick t22 (a rising edge of clock Clk2). However, this behavior does not satisfy assertion A20. Since the value of register R has changed from “2” to “4” at clock tick t22 (a rising edge of clock Clk2), the check processes CPi1 to CPi3 start at clock tick t22.

When the check processes CPi1 to CPi3 start, the global variable C is incremented in the check processes CPi1 to CPi3. In the present example, since there are 3 co-checker modules, C equals 3, i.e., the global variable C equals the number of clocks under which the given register R operates. C is successively decremented.

C is decremented and if all of the check processes CPi1 to CPi3 have ended before C equals 0, the evaluation to true of assertion A20 can be appropriately confirmed, without the false error depicted in FIG. 8 occurring between clock tick t22 when assertion A20 evaluates to true and the subsequent clock tick t23 (rising edges of clock Clk2). On the other hand, if C equals 0 when all of the check processes CPi1 to CPi3 end, a change in the value of register R, not defined by any assertion in the assertion group, has been detected.

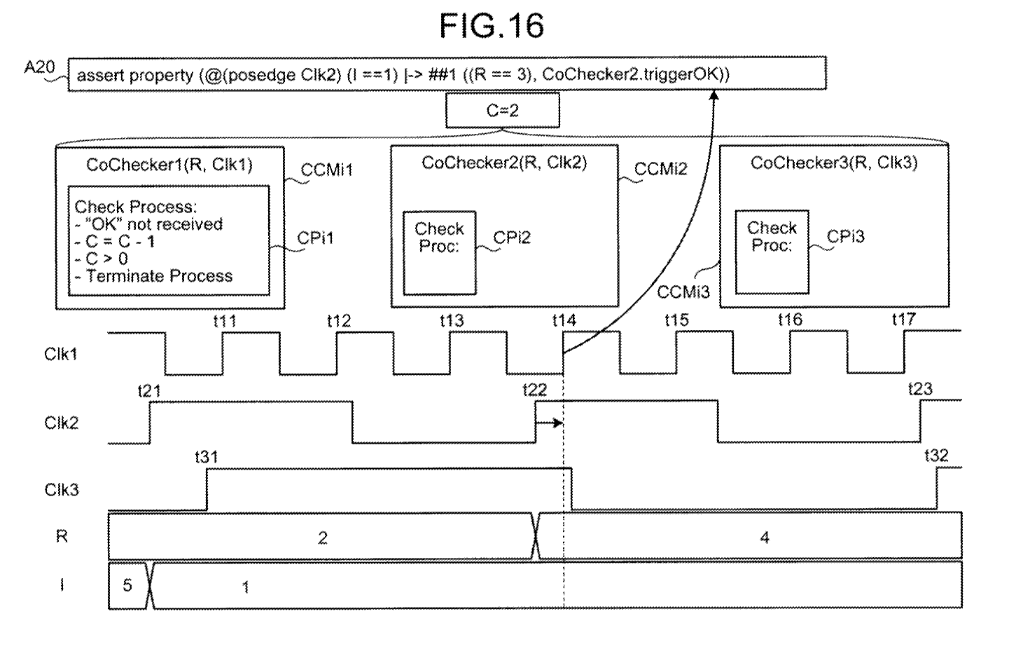

FIG. 16 depicts state transition from the state depicted in FIG. 15. In the description of FIG. 16, the clock tick at which register R operates subsequent to clock tick t22 is clock tick t14 (a rising edge of clock Clk1). Therefore, in co-checker module CCMi1 monitoring operation under clock Clk1, ‘assertion true’ notification of “OK” for assertion A20 is awaited, but time assertion A20 does not evaluate to true at clock tick t14. Therefore, in co-checker module CCMi1, since ‘assertion true’ notification of “OK” is not received at clock tick t14, the check process CPi1 decrements C, whereby C equals 2, and the check process CPi1 ends.

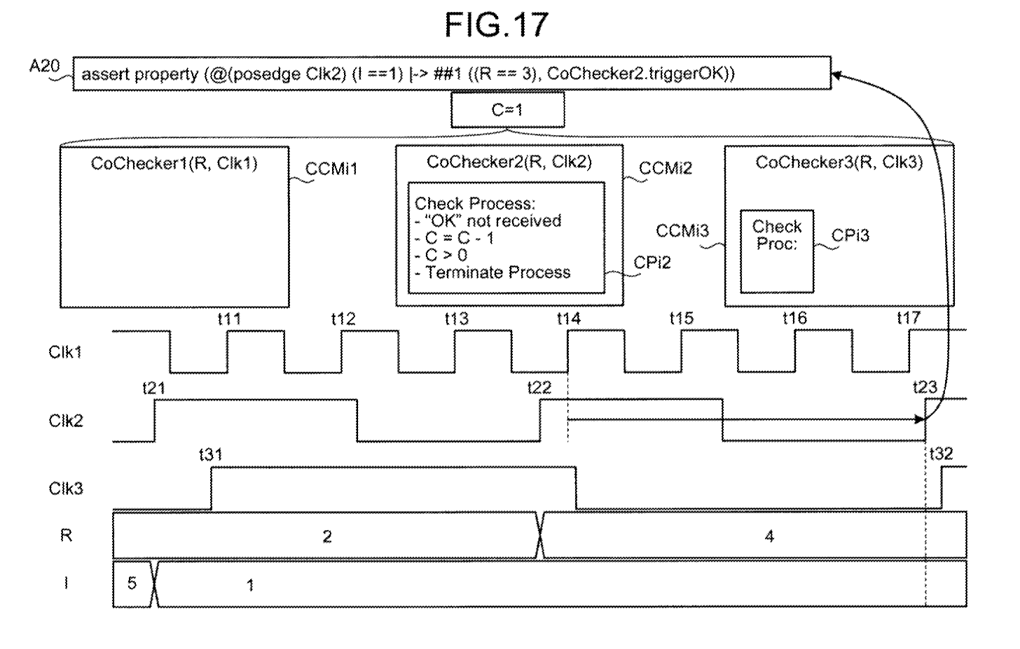

FIG. 17 depicts state transition from the state depicted in FIG. 1. In the description of FIG. 17, clock ticks at which register R operates subsequent to clock tick t14 (a rising edge of clock Clk1) when the check process CPi1 ends are clock ticks t15 to t17 of clock Clk1, but the check process CPi1 of co-checker module CCMi1 has ended. Therefore, the clock tick at which register R operates subsequent to clock tick t17 of clock Clk1 is clock tick t23 (a rising edge of clock Clk2) and in co-checker module CCMi2 monitoring operation under clock Clk2, ‘assertion true’ notification of “OK” for assertion A20 is awaited.

Although clock tick t23 is the clock tick subsequent to clock tick t22 when the register R changed under clock Clk2, assertion A20 evaluates to false. Therefore, in co-checker module CCMi2, since ‘assertion true’ notification of “OK” is not received at clock tick t23, the check process CPi2 decrements C, whereby C equals 1, and the check process CPi2 ends.

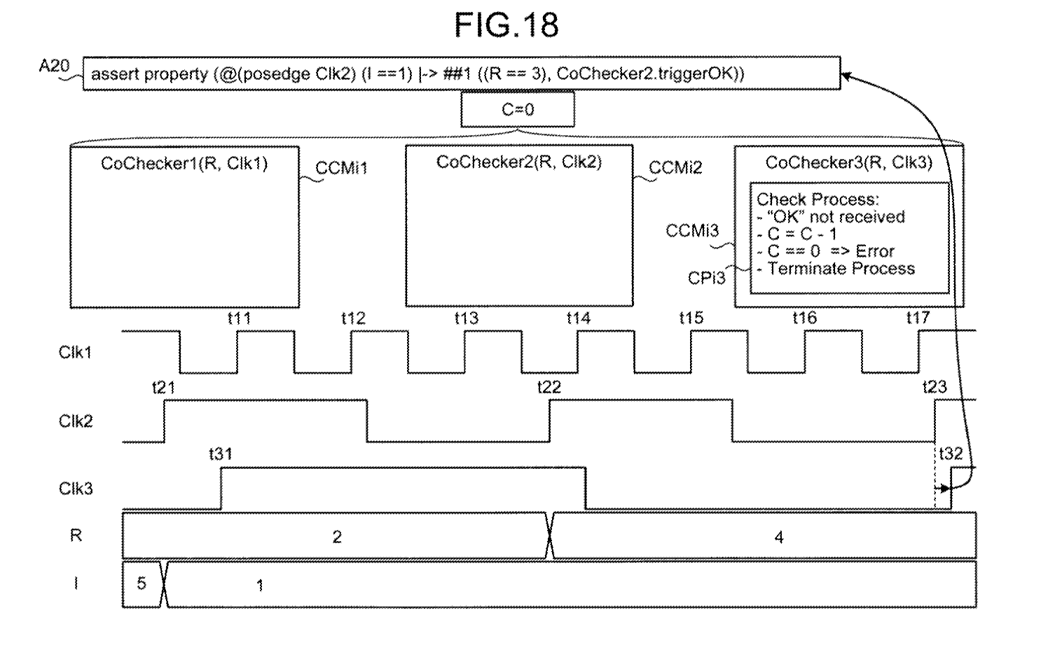

FIG. 18 depicts state transition from the state depicted in FIG. 17. In the description of FIG. 18, the clock tick at which register R operates subsequent to clock tick t23 of clock Clk2 when the check process CPi2 ends is clock tick t32 (a rising edge of clock Clk3). Therefore, in co-checker module CCMi3 monitoring operation under clock Clk3, ‘assertion true’ notification of “OK” for assertion A20 is awaited, but at clock tick t32, assertion A20 does not evaluate to true. Consequently, in co-checker module CCMi3, since ‘assertion true’ notification of “OK” is not received at clock tick t32, the check process CPi3 decrements C, whereby C equals 0, and the check process CPi3 ends.

In this way, since C equals 0 when all of the check processes CPi1 to CPi3 have ended, a change in the value of register R, not defined by any assertion in the assertion group, is detected at clock tick t22 (a rising edge of clock Clk2). Consequently, even when a register in a circuit-under-test operates under multiple clocks, a bug that cannot be detected by the assertion group can be efficiently detected, without the occurrence of the false error described above.

Next a functional configuration of the verification support apparatus according to the second embodiment will be described. Components identical to those in the first embodiment are given the same reference numerals used in the first embodiment and description therefor is omitted. Further, an example of a hardware configuration of the verification support apparatus according to the second embodiment is identical to that depicted in FIG. 2.

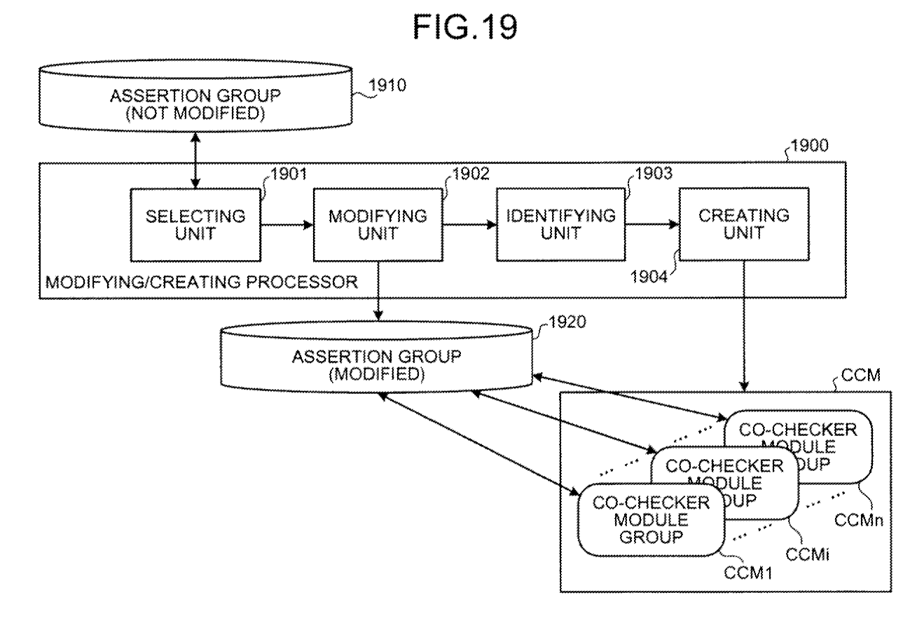

FIG. 19 is a block diagram of a functional configuration of the verification support apparatus according to the second embodiment. The verification support apparatus includes a modifying/creating processor 1900 and a co-checker module group set CCM. The modifying/creating processor 1900 includes a selecting unit 1901, a modifying unit 1902, an identifying unit 1903, and a creating unit 1904.

Respective functions of the modifying/creating processor 1900 (the selecting unit 1901 to the creating unit 1904) and the co-checker module group set CCM are implemented specifically, for example, by the CPU 201 executing a program stored to a storage device such as the ROM 202, the RAM 203, the magnetic disk 205, and the optical disk 207 depicted in FIG. 2, or via the I/F 209.

Assertion group 1910 is an assertion group prior to modification by the modifying/creating processor 1900. The assertion group 1910 includes assertions into which “CoChecker2.triggerOK” has not been inserted, such as assertion A20 depicted in FIG. 9 without “CoChecker2.triggerOK”. On the other hand, assertion group 1920 is the assertion group 1910 after modification by the modifying/creating processor 1900. An assertion in the assertion group 1920 is, for example, assertion A20 depicted in FIG. 9.

The selecting unit 1901 selects from the assertion group 1910, an assertion that has yet to be selected. The selecting unit 1901 continues selecting assertions until no unselected assertion remains. The modifying unit 1902 inserts into the assertion selected by the selecting unit 1901 (selected assertion), description related to ‘assertion true’ notification giving notification of an assertion evaluating to true. The inserted description related to ‘assertion true’ notification is description that calls up a subroutine that notifies the check process of an assertion evaluating to true.

Description related to ‘assertion true’ notification is, for example, “CoChecker2.triggerOK” depicted in FIG. 9. “CoChecker2.triggerOK” is a subroutine that issues “OK” to “CoChecker2”, if the assertion into which “CoChecker2.triggerOK” has been inserted, evaluates to true.

Typically, if it is desirable to give co-checker module CCMi# notification concerning an assertion evaluating to true at a rising edge of clock Clk# (or falling edge), adoption of “CoChecker#.triggerOK” is sufficient. Thus, at the modifying unit 1902, description related to ‘assertion true’ notification is inserted into each assertion, whereby after modification, the assertion group 1920 can be generated. The modified assertion group 1920 is referred to by the co-checker module group set CCM.

The identifying unit 1903 identifies, from the assertion into which the subroutine has been inserted, register identification information and clock identification information. Register identification information is information uniquely identifying a register and is, for example, a register name. Clock identification information is information uniquely identifying a clock and is, for example, a clock name. For example, if the selected assertion is assertion A20, “R” and “Clk2” are identified as the register name and the clock name, respectively.

The creating unit 1904, based on the register identification information and the clock identification information identified by the identifying unit 1903, creates a co-checker module group. Specifically, for example, since the number of clocks is known (herein, the 3 clocks, Clk1 to Clk3), if clock name “Clk2” is identified, for the identified register R, co-checker modules CCMi1 to CCMi3 are created. The creating unit 1904 preliminarily retains operation description for co-checker module CCMi as a template and therefore, can create a co-checker module by merely providing a register name and a clock name to the template.

The co-checker module group set CCM includes co-checker module groups CCM1, . . . , CCMi, . . . , CCMn, where “n” is the number of registers described by an assertion. The co-checker module groups CCMi execute the same processing, but the registers and assertions (assertions in the assertion group 1920) subject to the processing respectively differ among the co-checker module groups CCMi.

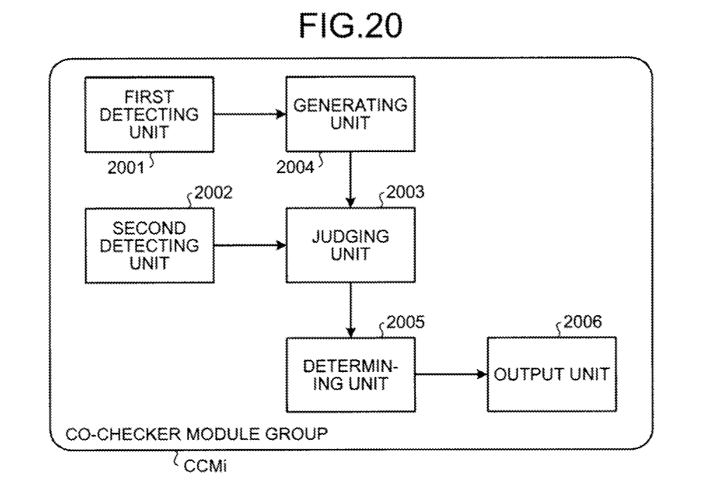

FIG. 20 is a block diagram of a functional configuration of a co-checker module group CCMi. A co-checker module group CCMi includes a first detecting unit 2001, a second detecting unit 2002, a judging unit 2003, a generating unit 2004, a determining unit 2005, and an output unit 2006.

Functions of the first detecting unit 2001 to the output unit 2006, specifically, for example, are implemented by the CPU 201 executing a program stored to a storage device such as the ROM 202, the RAM 203, the magnetic disk 205, and the optical disk 207 depicted in FIG. 2, or via the I/F 209.

The first detecting unit 2001 detects an assertion that evaluates to true during simulation of the circuit. The assertion is detected from an assertion group prescribing for a register R in the circuit operating under multiple clocks, values to be met by the circuit, at the timing of any one of the clocks.

Specifically, for example, from the assertion group 1920 concerning a circuit-under-test having an internal register R that operates under 3 clocks (clocks Clk1 to Clk3), the first detecting unit 2001 detects an assertion that evaluates to true during simulation. For example, as depicted in FIG. 20, the first detecting unit 2001 detects in the assertion group 1920, assertion A20, which has evaluated to true at clock tick t22.

The second detecting unit 2002 detects a change in the value of register R. Here, a change in the value of register R is irrespective of whether an assertion evaluates to true. For example, using co-checker module CCMi2, the second detecting unit 2002, as depicted in FIG. 10, detects the change (“2”→“3”) in the value of register R occurring at clock tick t22 of clock Clk2. Similarly, using co-checker module CCMi2, the second detecting unit 2002, as depicted in FIG. 15, detects the change (“2”→“4”) in the value of register R at clock tick t22 of clock Clk2.

The judging unit 2003 judges for each of the clock ticks immediately subsequent to the detection of a change in the register value by the second detecting unit, whether the clock to which the clock tick belongs is the clock prescribed by the assertion detected by the first detecting unit 2001. Specifically, for example, the judging unit 2003 is not executed if an assertion that evaluates to true is not detected by the first detecting unit 2001, i.e., in the example depicted in FIGS. 14 to 18, the judging unit 2003 is not executed.

On the other hand, in the example depicted in FIGS. 9 to 13, in the state depicted in FIG. 10, the evaluation to true of assertion A20 is detected. Therefore, the judging unit 2003, as depicted in FIG. 11, judges whether the clock tick t14 immediately subsequent to clock tick t22 when a change in the value of the register R was detected, is of the same clock (clock Clk2) prescribed by assertion A20 that has evaluated to true. Since clock tick t14 belongs to clock Clk1, the clock is not the same as that (clock Clk2) prescribed by assertion A20.

Similarly, the judging unit 2003, as depicted in FIG. 12, judges whether clock tick t23 immediately subsequent to clock tick t22 when the change in the value of register R was detected, is of the same clock (clock Clk2) prescribed by assertion A20 that has evaluated to true. Since clock tick t23 belongs to clock Clk2, the clock is the same as that (clock Clk2) prescribed by assertion A20.

Further, the judging unit 2003, as depicted in FIG. 13, judges whether clock tick t32 immediately subsequent to clock tick t22 when a change in the value of register R was detected, is of the same clock (clock Clk2) prescribed by assertion A20 that has evaluated to true. Since clock tick t32 belongs to clock Clk3, the clock is not the same as that (clock Clk2) prescribed by assertion A20.

If a change in the value of register R is detected by the second detecting unit 2002, the generating unit 2004, generates for each clock of register R, a check process that awaits ‘assertion true’ notification giving notification of assertion evaluation to true. Specifically, for example, as depicted in FIGS. 9 to 18, the generating unit 2004 generates for each co-checker module CCMi1 to CCMi3, a respective check process CPi1 to CPi3. Upon generation of the check processes CPi1 to CPi3, each of the check processes CPi1 to CPi3 increments the global variable C. Thus, C equals the total number of clocks Clk1 to Clk3 m.

Thereafter, in the example of FIGS. 9 to 13, upon judgment that the clocks are the same by the judging unit 2003, the subroutine specified by the description related to ‘assertion true’ notification and inserted into the assertions, is called up. Consequently, among co-checker modules CCMi1 to CCMi3, co-checker module CCMi2 related to the same clock (clock Clk2) is able to receive ‘assertion true’ notification by the execution of the notification subroutine called up.

In the example depicted in FIGS. 14 to 18, since no assertion evaluates to true, the clocks are not judged to be the same by the judging unit 2003. In the example depicted in FIGS. 9 to 13 and in the example depicted in FIGS. 14 to 18, the global variable C is decremented each time the clocks are determined to not be the same.

The determining unit 2005, based on the judgment result obtained by the judging unit 2003, determines whether the change in the value of register R is valid. Specifically, for example, according to a judgment that the clocks are the same by the judging unit 2003, if clock Clkj among clocks Clk1 to Clkm is judged to be the same clock as that prescribed, C will not become 0 even if the global variable C is decremented and therefore, the change in the value of register R is determined to be a correct change that is expected.

For example, as depicted by the example in FIGS. 9 to 13, since clock Clk2 to which clock tick t23 belongs and clock Clk2 of assertion A20 that has evaluated to true are judged to be the same clock, the change in the value of register R at clock tick t22 of clock Clk2 is determined to be a correct change that is expected (according to assertion A20).

On the other hand, according to a judgment that the clocks are not the same by the judging unit 2003, if none of the clocks among clocks Clk1 to Clkm is judged to be the same clock as that prescribed, the global variable C is decremented and eventually becomes 0. Accordingly, the determining unit 2005 determines the change in the value of register R to be an erroneous change that is not defined by any assertion.

For example, as depicted by the example in FIGS. 14 to 18, since assertion A20 does not evaluate to true with the change in the value of register R at clock tick t22 of clock Clk2, the notification subroutine is not called up by the description related to ‘assertion true’ notification inserted into the assertions and in each case, C is consequently decremented to eventually become 0. Thus, the determining unit 2005 determines the change in the value of register R at clock tick t22 of clock Clk2 to be an erroneous change that is not defined by any assertion.

The output unit 2006 outputs the determination result obtained by the determining unit 2005. Specifically, for example, the output unit 2006 outputs the clock detecting the change in the value of register R, the clock tick of the change, and identification information for register R, if the change is determined by the determining unit 2005, to be an erroneous change. Identification information is information uniquely identifying register R and is, for example, a register name. For instance, in the example depicted in FIGS. 14 to 18, the output unit 2006 outputs {NG, clock Clk2, clock tick t22, R}. Here, the value of register R may also be output. In this case, the output unit 2006 outputs {NG, clock Clk2, clock tick t22, R=4}.

Further, the output unit 2006 may output the clock detecting the change in the value of register R, the time of the change, and identification information for register R, if the change is determined by the determining unit 2005, to be a correct change. For instance, in the example depicted in FIGS. 9 to 13, the output unit 2006 outputs {OK, clock Clk2, clock tick t22, R}. Here, the value of the register R may also be output. In this case, the output unit 2006 outputs {OK, clock Clk2, clock tick t22, R=3}.

Further, the output unit 2006 may output the clock detecting the change in the value of register R, the clock tick at which ‘assertion true’ notification of “OK” was received, and identification information for register R, if the change is determined by the determining unit 2005, to be a correct change. For instance, in the example depicted in FIGS. 9 to 13, the output unit 2006 outputs {OK, clock Clk2, clock tick t23, R}. Here, the value of register R may also be output. In this case, the output unit 2006 outputs {OK, clock Clk2, clock tick t23, R=3}.

The output unit 2006 may output such results by display on the display 208, print out by the printer 213, and transmission to a communicable computer. Further, the output unit 2006 may store the results to an internal storage device of the verification support apparatus.

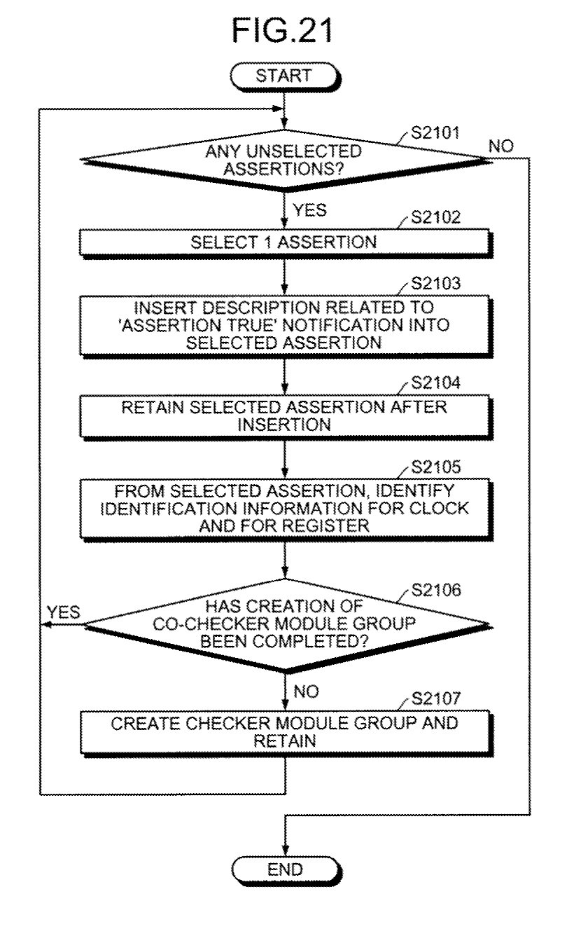

FIG. 21 is a flowchart of a modification/creation process executed by the verification support apparatus according to the second embodiment. The selecting unit 1901 judges whether an assertion that has yet to be selected remains in the assertion group 1910 (step S2101).

If an unselected assertion remains (step S2101: YES), the selecting unit 1901 selects an unselected assertion from the assertion group 1910 (step S1902). The modifying unit 1902 inserts into the selected assertion, description related to calling up an ‘assertion true’ notification subroutine that gives ‘assertion true’ notification (step S2103). Thereafter, the modifying unit 1902 retains the selected assertion after the insertion, in an internal storage device of the verification support apparatus (step S2104).

Further, the identifying unit 1903, from the selected assertion, identifies identification information for the clock prescribed by selected assertion and identification information for the register also prescribed (step S2105). The creating unit 1904, based on the identified clock identification information and the identified register identification information, judges whether creation of the co-checker module group CCMi has been completed (step S2106).

If creation has been completed (step S2106: YES), the flow returns to step S2101. On the other hand, if creation has not been completed (step S2106: NO), the creating unit 1904 creates the co-checker module group CCMi based on the identified clock identification information and register identification information, and retains the co-checker module group CCMi in a storage device (step S2107). Subsequently, the flow proceeds to step S2101.

At step S2101, if no unselected assertion remains (step S2101: NO), the modification/creation process ends. Thus, the unmodified assertion group 1910 is modified into the assertion group 1920 into which description related to ‘assertion true’ notification has been inserted, whereby if an assertion evaluates to true during a check process of the co-checker module group set CCM, the validity of the change in the value of register R can be identified without the occurrence of a false error.

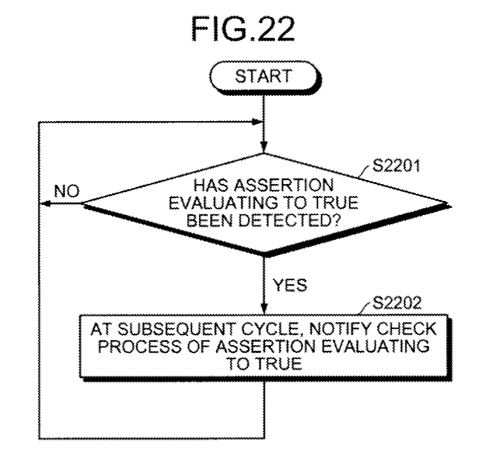

FIG. 22 is a flowchart of an ‘assertion true’ notification process executed by co-checker module CCMij during simulation of the circuit-under-test.

First, the co-checker module CCMij waits until the first detecting unit 2001 detects in the assertion group 1920, an assertion evaluating to true for a register R under test by the co-checker module group CCMi (step S2201: NO). When an assertion is detected (step S2201: YES), the co-checker module CCMij by reading out the description in the assertion that has evaluated to true, gives ‘assertion true’ notification of “OK” to the check process CPij of the co-checker module CCMij (step S2202), and the flow returns to step S2201. The processing of the flowchart in FIG. 22 ends with the completion of the simulation of the circuit-under-test.

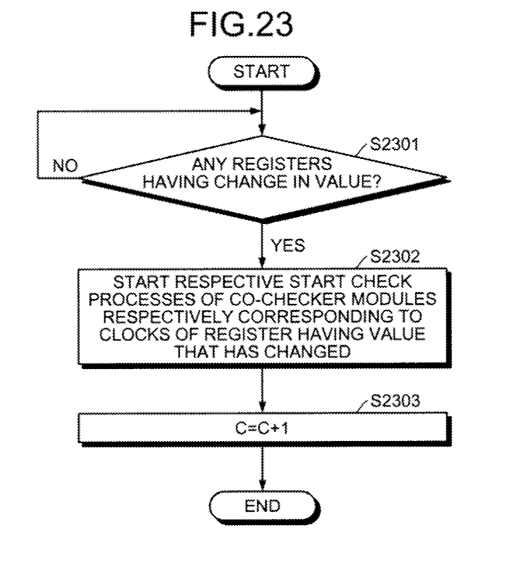

FIG. 23 is a flowchart of a startup process executed by a co-checker module CCMij, for the check process CPij occurring during simulation of the circuit-under-test. First, the co-checker module CCMij waits until the second detecting unit 2002 detects a change in the value of register R under test by the co-checker module group CCMi (step S2301: NO). When a change in the value of register R is detected (step S2301: YES), the co-checker module CCMij starts the check process CPij (step S2302).

Subsequently, the global variable C is incremented (step S2303). Since the number of co-checker modules CCMij corresponds to the total number of clocks m, each of the co-checker modules CCMij increments the global variable C, whereby C equals m, ending the startup process for the check process CPij.

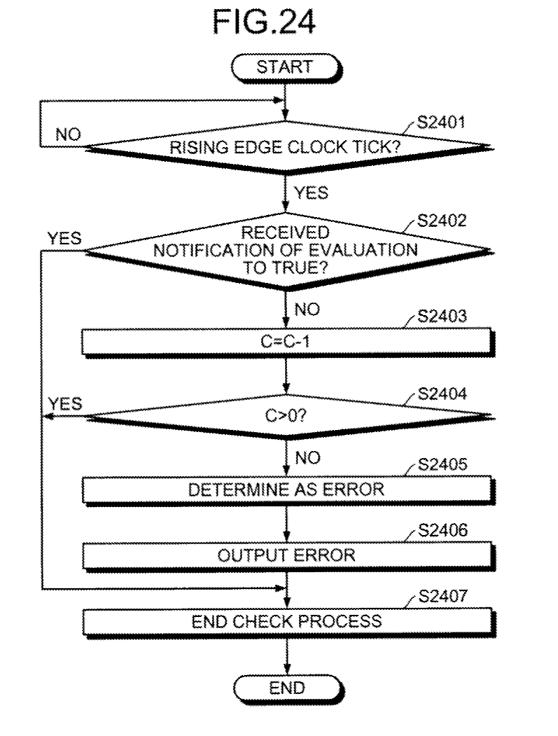

FIG. 24 is a flowchart of an execution process of the check process CPij started according to the flowchart depicted in FIG. 23. In FIG. 24, the detection at a rising edge clock tick of clock Clk is given as an example, but alternatively may be at a falling edge clock tick.

First, the second detecting unit 2002 awaits a rising edge clock tick of clock Clk (step S2401: NO) and upon a rising edge clock tick (step S2401: YES), judges whether ‘assertion true’ notification of “OK” has been received from the co-checker module CCMij (step S2402). If ‘assertion true’ notification of “OK” has been received (step S2402: YES), without decrementing the global variable C, the check process CPij ends (step S2407).

On the other hand, if ‘assertion true’ notification of “OK” has not been received (step S2402: NO), the judging unit 2003 decrements the global variable (step S2403), and judges whether the resulting value of C is greater than 0 (step S2404). If C is greater than 0 (step S2404: YES), the flow proceeds to step S2407, and the check process CPij ends (step S2407).

On the other hand, if C is not greater than 0 (step S2404: NO), the determining unit 2005 determines the change in the value of register R to be an erroneous change not defined by any assertion (step S2405). Subsequently, the output unit 2006 outputs the determination result obtained by the determining unit 2005 (step S2406), and the check process CPij ends (step S2407).

Thus, in the second embodiment, each time an assertion evaluates to true, a check process CPij is started for each co-checker module CCMij, and ‘assertion true’ notification is awaited. If there is even 1 check process CPij that has received ‘assertion true’ notification, the change in the value of register R is guaranteed to be a change expected according to an assertion. On the other hand, if there it not even 1 check process CPij that has received ‘assertion true’ notification, the change in the value of register R is clearly an erroneous change not prescribed by any assertion.

Thus, in the second embodiment, if an assertion has evaluated to true, the event of an assertion evaluating to true can be appropriately confirmed, without the occurrence of a false error like that the depicted in FIG. 8. Further, if the value of register R merely changes without an assertion evaluating to true, a change in the value of register R, not defined by any assertion in the assertion group, can be detected.

In this way, even if register R in the circuit-under-test operates under multiple clocks, a bug that cannot be detected by the assertion group can be efficiently detected without the occurrence of the false error above. Further, by the verification engineer debugging identified bugs, the value of register R can be guaranteed to not change outside the assertions concerning the circuit-under-test.

The verification support method described in the present embodiment may be implemented by executing a prepared program on a computer such as a personal computer and a workstation. The program is stored on a computer-readable medium such as a hard disk, a flexible disk, a CD-ROM, an MO, and a DVD, read out from the recording medium, and executed by the computer. The program may be distributed through a network such as the Internet. However, the computer-readable medium does not include a transitory medium such as a propagation signal.

According to one embodiment of the present invention, easy identification of a bug occurring outside scenarios defined for a circuit is possible.

A11 examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable medium storing therein a verification support program that causes a computer to execute a process, the process comprising:
first detecting an assertion that evaluates to true during simulation of a circuit, the assertion being detected from an assertion group prescribing values of registers to be met by the circuit;
updating, at a clock tick subsequent to a clock tick at which the assertion is detected at the first detecting, an expected value of a register, to a value of the register as prescribed by the assertion;
second detecting inconsistency between the expected value that has been updated at the updating and the value of the register;
determining, based on a detection result obtained at the second detecting, validity of a change in the value of the register; and
outputting a determination result obtained at the determining.

2. The computer-readable medium according to claim 1, wherein
the determining includes determining the change in the value of the register to be a change not prescribed by the assertion group, if at the second detecting, inconsistency is detected between the expected value after the updating at the updating and the value of the register.

3. The computer-readable medium according to claim 1, wherein
the determining includes determining the change in the value of the register to be an expected change, if at the second detecting, consistency is detected between the expected value after the updating at the updating and the value of the register.

4. The computer-readable medium according to claim 1, wherein
the outputting includes outputting the clock tick at which the inconsistency has been detected and identification information of the register.

5. The computer-readable medium according to claim 1, wherein
the outputting includes outputting a clock tick subsequent to the clock tick at which the inconsistency has been detected and identification information of the register.

6. The computer-readable medium according to claim 1, the process further comprising executing the first detecting, the updating, the second detecting, and the determining, with respect to each of the registers in the circuit.

7. The computer-readable medium according to claim 1, the process further comprising:
selecting successively unselected assertions, from the assertion group; and
modifying the assertion group by inserting into each assertion selected at the selecting, update instruction description instructing updating of the expected value, wherein
the first detecting includes detecting from the assertion group that has been modified at the modifying, the assertion that evaluates to true during simulation of the circuit,
the updating includes updating the expected value according to the update instruction description inserted into the assertion detected at the first detecting, the expected value being updated to the value of the register prescribed by the assertion detected at the first detecting.

8. A computer-readable medium storing therein a verification support program that causes a computer to execute a process, the process comprising:
first detecting an assertion that evaluates to true during simulation of a circuit, the assertion being detected from an assertion group prescribing for a given register operating under a plurality of clocks in the circuit, values to be met at a timing of any of the clocks;
second detecting a change in the value of the given register;
judging for each clock tick immediately subsequent to a detection at the second detecting, whether the clock to which the clock tick belongs is the clock prescribed by the assertion detected at the first detecting;
determining, based on a judgment result obtained at the judging, validity of the change in the value of the given register; and
outputting a determination result obtained at the determining.

9. The computer-readable medium according to claim 8, wherein
the determining includes determining the change in the value of the given register to be an expected change, if the clock to which the clock tick belongs is judged at the judging to be the clock prescribed by the assertion detected at the first detecting.

10. The computer-readable medium according to claim 8, wherein
the determining includes determining the change in the value of the given register to be a change not prescribed by the assertion group, if no assertion evaluating to true is detected at the first detecting and a change in the value of the given register is detected at the second detecting.

11. The computer-readable medium according to claim 8, the process further comprising:
generating, for each of the clocks of the given register, a check process that awaits notification that the assertion has evaluated to true, the check processes being generated if a change in the value of the given register is detected at the second detecting, wherein
the judging includes judging whether a check process among the generated check processes has received from the assertion, the notification that the assertion has evaluated to true.

12. The computer-readable medium according to claim 11, wherein
the determining includes determining the change in the value of the given register to be an expected change, if a check process is judged at the judging to have received the notification of the assertion evaluating to true.

13. The computer-readable medium according to claim 11, wherein
the determining includes determining the change in the value of the given register to be a change not prescribed by the assertion group, if no check process is judged at the judging to have received the notification of the assertion evaluating to true.

14. The computer-readable medium according to claim 10, the process further comprising:
selecting successively unselected assertions, from the assertion group; and
modifying the assertion group by inserting, into each assertion selected at the selecting, description related to the notification of the assertion evaluating to true, wherein
the first detecting includes detecting from the assertion group that has been modified at the modifying, the assertion that evaluates to true during simulation of the circuit.

15. The computer-readable medium according to claim 11, the process further comprising:
selecting successively unselected assertions, from the assertion group; and
modifying the assertion group by inserting, into each assertion selected at the selecting, description related to the notification of the assertion evaluating to true, wherein
the first detecting includes detecting from the assertion group that has been modified at the modifying, the assertion that evaluates to true during simulation of the circuit.

16. The computer-readable medium according to claim 8, wherein
the outputting includes outputting the clock tick at which the change in the value of the given register has been detected and identification information of the given register.

17. The computer-readable medium according to claim 8, wherein
the outputting includes outputting the clock tick that is immediately subsequent to the clock tick when the change in the value of the given register occurred and identification information of the given register.

18. The computer-readable medium according to claim 8, the process further comprising executing the first detecting, the second detecting, the judging, and the determining with respect to each register in the circuit.

19. A verification support apparatus comprising:
a first detecting unit that detects an assertion evaluating to true during simulation of a circuit, the assertion being detected from an assertion group prescribing values of registers to be met by the circuit;
an updating unit that updates, at a clock tick subsequent to a clock tick at which the assertion is detected by the first detecting unit, an expected value of a register, to a value of the register as prescribed by the assertion;
a second detecting unit that detects inconsistency between the expected value that has been updated by the updating unit and the value of the register; (403)
a determining unit that determines, based on a detection result obtained by the second detecting unit, validity of a change in the value of the register; (404) and
an output unit that outputs a determination result obtained by the determining unit.

20. A verification support apparatus comprising:
a first detecting unit that detects an assertion evaluating to true during simulation of a circuit, the assertion being detected from an assertion group prescribing for a register operating under a plurality of clocks in the circuit, values to be met at a timing of any of the clocks;
a second detecting unit that detects a change in the value of the given register;
a judging unit that, for each clock tick immediately subsequent to a detection by the second detecting unit, judges whether the clock to which the clock tick belongs is the clock prescribed by the assertion detected by the first detecting unit;
a determining unit that, based on a judgment result obtained by the judging unit, determines validity of the change in the value of the given register; (2005) and
an output unit that outputs a determination result obtained by the determining unit.

21. A verification support method executed by a computer, the verification support method comprising:
first detecting an assertion that evaluates to true during simulation of a circuit, the assertion being detected from an assertion group prescribing values of registers to be met by the circuit;
updating, at a clock tick subsequent to a clock tick at which the assertion is detected at the first detecting, an expected value of a register, to a value of the register as prescribed by the assertion;
second detecting inconsistency between the expected value that has been updated at the updating and the value of the register;
determining, based on a detection result obtained at the second detecting, validity of a change in the value of the register; and
outputting a determination result obtained at the determining.

22. A verification support method executed by a computer, the verification support method comprising:
first detecting an assertion that evaluates to true during simulation of a circuit, the assertion being detected from an assertion group prescribing for a given register operating under a plurality of clocks in the circuit, values to be met at a timing of any of the clocks;
second detecting a change in the value of the given register;
judging for each clock tick immediately subsequent to a detection at the second detecting, whether the clock to which the clock tick belongs is the clock prescribed by the assertion detected at the first detecting;
determining, based on a judgment result obtained at the judging, validity of the change in the value of the given register; and
outputting a determination result obtained at the determining.
